(19) United States
(12) Patent Application Publication
(10) Pub. No.: US 2015/0302653 A1
(43) Pub. Date: Oct. 22, 2015

(54) Augmented Digital Data

(71) Applicant: Cherif Atia Algreatly, Fremont, CA (US)

(72) Inventor: Cherif Atia Algreatly, Fremont, CA (US)

(21) Appl. No.: 14/692,730

(22) Filed: Apr. 21, 2015

Related U.S. Application Data
(60) Provisional application No. 61/995,886, filed on Apr. 22, 2014.

(51) Int. Cl. G06T 19/00; H04N 9/31; G02B 27/01; G06F 3/00; G06F 3/01

(52) U.S. Cl. CPC G06T 19/006; G06F 3/005; G06F 3/017; G02B 27/017; H04N 9/31; G06T 2215/16

(57) ABSTRACT

A system for augmented digital data is disclosed. The system is comprised of a first electronic device and a second electronic device. The first electronic device is comprised of a first display presenting a first digital data. The second electronic device is comprised of a second display and input device. The second electronic device is simultaneously presenting a second digital data while the first display is presenting the first digital data. An image of the second electronic device including the second display and input device are presented on the first display, with an image of the user's hands/digits overlaying the image of the input device to indicate their relative location. Accordingly, the system allows the user to simultaneously use multiple electronic devices without gaze altering interruption occurring.

### CROSS-REFERENCE TO RELATED APPLICATION

This application claims the benefits of a U.S. Provisional Patent Application No. 61/995,886, filed Apr. 22, 2014.

### BACKGROUND

There are many conceivable cases where a person may need to simultaneously view two or more displays. For example, while watching television, it may be necessary to write an email using a computer. Composing an email while watching television requires the user to move their head or eyes from the computer screen to the television screen. An annoying distraction, this back & forth could lead to the user missing parts of their show or movie playing on the television, or make mistakes in the email's composition. This problem, which occurs when simultaneously using two or more electronic devices, is in a dire need of a solution which can return ease of use to the user and increase productivity when performing multiple tasks. This include, but not limited to, the use of computers, televisions, mobile phones, tablets, digital cameras, head-mounted computer displays or the like.

### SUMMARY

The present invention discloses a method that resolves the aforementioned difficulty by allowing the user to simultaneously view two or more displays of a computer, television, mobile phone, tablet, digital camera, head-mounted computer display or the like. This efficiently reduces the rate of gaze altering interruption, therefor increasing the user's efficiency when performing multiple tasks at the same time.

In one embodiment, the present invention is comprised of a first electronic device and a second electronic device. The first electronic device is comprised of a first display presenting a first digital data. The second electronic device is comprised of a second display and input device. The second electronic device is simultaneously presenting a second digital data while the first display is presenting the first digital data. An image of the second electronic device, including the second display and input device, are presented on the first display along with an image of the user's hands/digits overlaying the image of the input device to indicate their relative location. The image of the user's hand/digits is transplant so that the user is visually aware of their hand placement without needing to avert their gaze.

In some embodiments, the images of the second electronic device and user's hand/digits on the input device are presented in different ways on the first display to account for whatever may suit the user. These images can be presented on one side of the first display so that they do not hide the first digital data. The first digital data and the images can also be resized and relocated on the first display to present the first digital data and the images beside each other. Additionally, the images can be transparent and presented on top of the first digital data on the first display.

The user can independently move, show or hide the image of the second display and/or the image of the input device on the first display to better suit their preference. For example, if the first display is a television display and the second electronic device is a laptop, the user can move the image of the laptop display to one side of the television display and move the image of the laptop keyboard to another side of the television display. The image of the user's hands/digits appears at the new location of the laptop keyboard image. Also, the user can increase the size of the image of the laptop display without changing the size of the image of the laptop keyboard, or vise versa.

In another embodiment, the present invention simultaneously utilizes three different displays, such as a television screen, mobile phone display and head mounted display. For example, the television display may present a movie while the user interacts with a digital data on their mobile phone display. The head mounted display presents the images of the television screen, the mobile phone display, and the user's hands/digits on the mobile phone display, allowing the user to view the movie and interact with the mobile phone display without requiring them to look at their television and mobile phone. Additionally, the user can also resize, relocate, show or hide the image of the televisions screen or mobile phone display according to their needs.

Generally, while multiple embodiments are disclosed, other embodiments will become apparent to those skilled in the art from the following Detailed Description. As will be realized, the embodiments are capable of modifications in various aspects, all without departing from the spirit and scope of the embodiments discussed herein. Accordingly, the drawings and detailed description are to be regarded as illustrative in nature and not restrictive.

### BRIEF DESCRIPTION OF DRAWINGS

FIG. 1 illustrates a television screen displaying a movie and images of a laptop display and keyboard with the user's actual hand positioning relative to the laptop.

FIG. 2 illustrates repositioning the image of the laptop display so that it is separated from the image of the laptop keyboard shown on the television screen.

FIG. 3 illustrates moving the image of the laptop keyboard and enlarging the image of the laptop display shown on the television screen.

FIG. 4 illustrates resizing and relocating the movie being played and the images of the laptop shown on the television screen.

FIG. 5 illustrates enlarging the image of the laptop display and shrinking the window of the movie played on the television screen

FIG. 6 illustrates slanting the images of the laptop display and laptop keyboard to suite the user's spatial, body position.

FIG. 7 illustrates an image of a mobile phone located on the lower left corner of a television screen.

FIG. 8 illustrates the image of a user's mobile phone and hand presented on a television screen while the user talks on the mobile phone.

FIG. 9 illustrates a head-mounted computer display which presents to the user a first image of television screen and a second image of a laptop.

FIG. 10 illustrates a head-mounted display presenting three images of three electronic devices.

FIG. 11 illustrates a user holding a pencil to write on a piece of paper while looking at a television screen that presents the picture of the paper and the position of the pencil.

FIG. 12 illustrates three images of a GPS, radio and mobile phone projected on the front glass of a car.

### DETAILED DESCRIPTION OF INVENTION

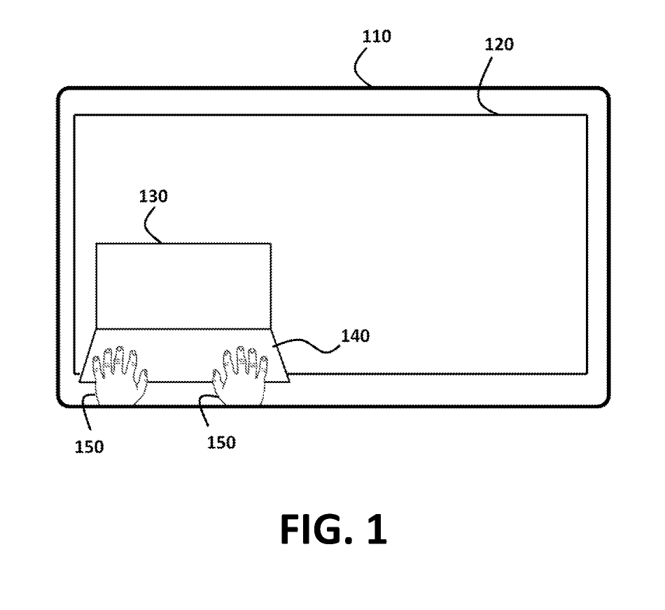

The present invention discloses a system and method that allow the user to maintain constant contact with multiple electronic devices, eliminating the disruptive need to interact separately with each electronic device. For example, FIG. 1 illustrates a television screen 110 playing a movie 120 with an image of a laptop, including the laptop display 130 and the laptop keyboard 140, overlaid in the lower left corner. Image 150 represents the current position of the user's hand relative to the laptop keyboard. Presenting the images of the laptop display, laptop keyboard, and the user's hands on the television screen allows the user to watch the movie and work on the laptop at the same time. Doing this relieves the user from the pitfalls of distraction because the movie and laptop image are shown on one screen conveniently in the user's line of sight.

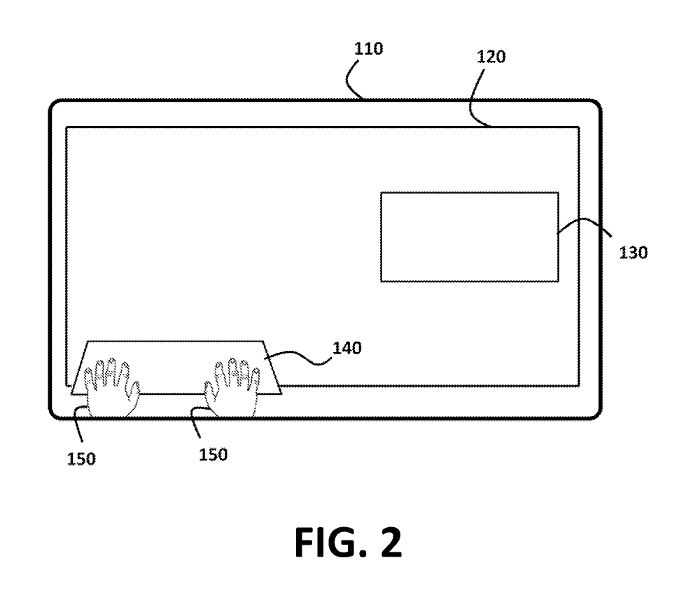

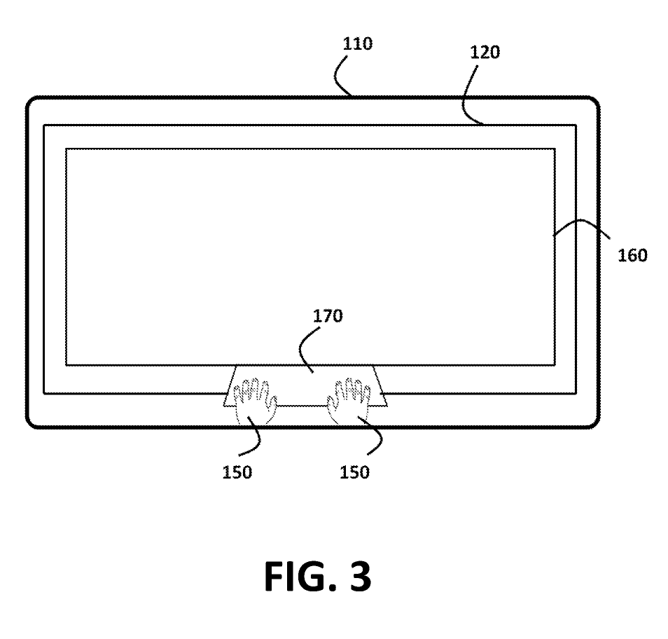

The user is free to move, resize, show or hide the images of the laptop display and keyboard according to their preference. For example, FIG. 2 illustrates moving the image 130 of the laptop display to another position on the television screen. FIG. 3 illustrates enlarging the image of the laptop display 150 and shrinking the image of the laptop keyboard 160, which is centered at the bottom of the television screen. It is important to note that, the image of the user's hands is transparent so that the user can be visually aware of their hand placement relative to the laptop in real-time. If the image of the laptop obscures a large area of the television screen, then the laptop image becomes transparent making it possible to see the movie presented beneath on the television screen.

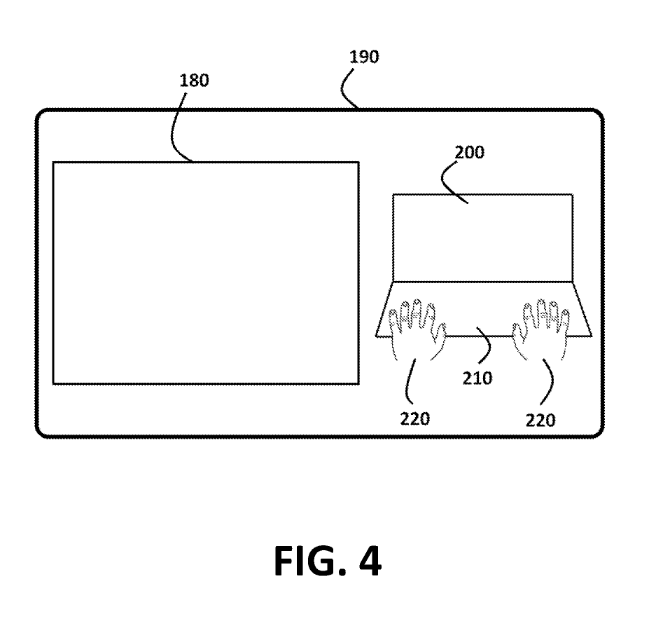

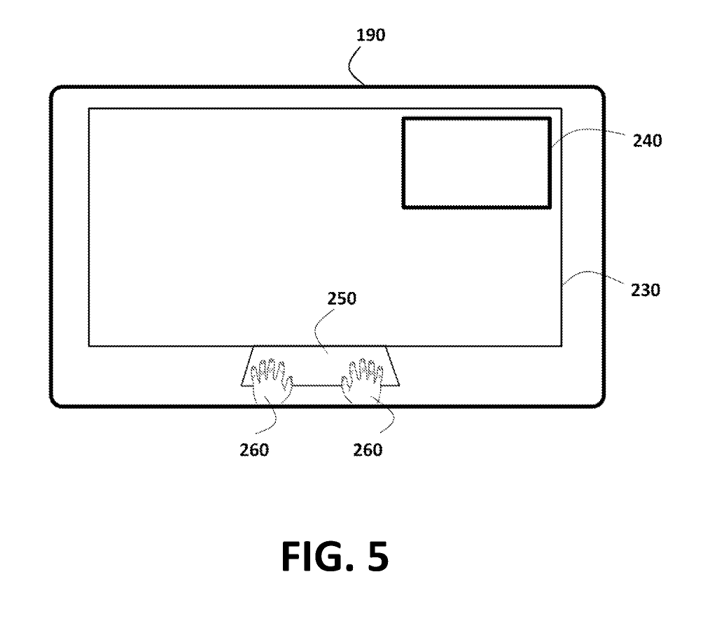

FIG. 4 illustrates another example of how the user may wish to resize the window of the movie 180 played on the television screen 190, so that the images of the laptop display 200, laptop keyboard 210 and user's hand 220 are positioned beside the movie window. FIG. 5 illustrates enlarging the image of the laptop display 230 and shrinking the window of the movie 240, so that it is located at the top right corner of the laptop display. As shown in the figure, the images of the laptop keyboard 250 and user's hands 260 are centered at the bottom of the television screen 270.

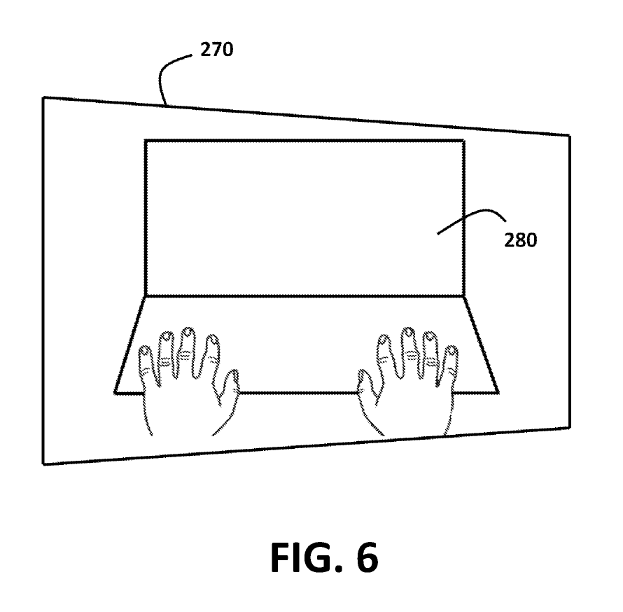

FIG. 6 illustrates how the television display 270 could appear to a user who is not seated precisely in front of the television display. In such a case, the user can adjust the image of the laptop 280 including the laptop display and keyboard, to appear slanted, so the user feels as if they are seated directly in front of the television screen. In other words, the image of the laptop can be reshaped to suit the user's position or point of view.

As can be seen in the previous different examples, the user can watch television and work on the laptop without the need to move their head or eyes between the television and laptop. Moreover, the user can view the laptop display in any size regardless of the physical dimensions of the material or real laptop. Also the user can still view the image of the laptop keyboard beneath their hands, eliminating tendency for typos which occur while typing or performing general interaction with the application presented on the laptop display.

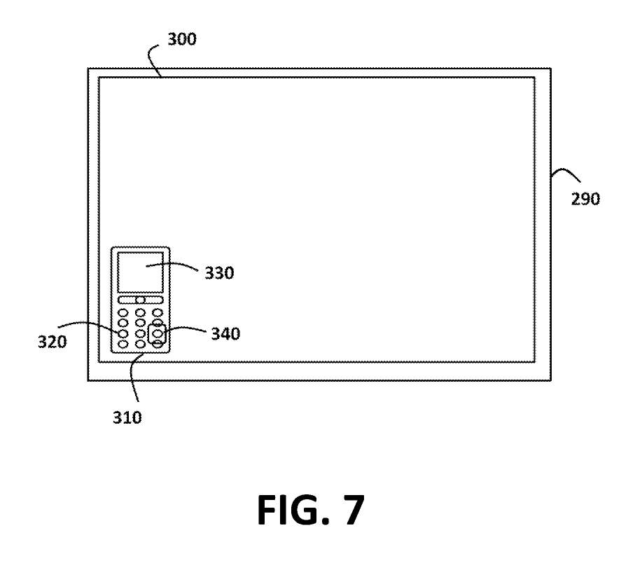

FIG. 7 illustrates a television screen 290 presenting a movie 300 and image of a mobile phone 310. The image of the mobile phone shows the mobile phone keyboard 320 and the mobile phone screen 330. The small square 340 represents the position of the user's finger when touching the mobile phone keyboard. In this scenario, the user can interact with the mobile phone touchscreen or keyboard without having to look at the mobile phone while watching a movie or show on the television screen.

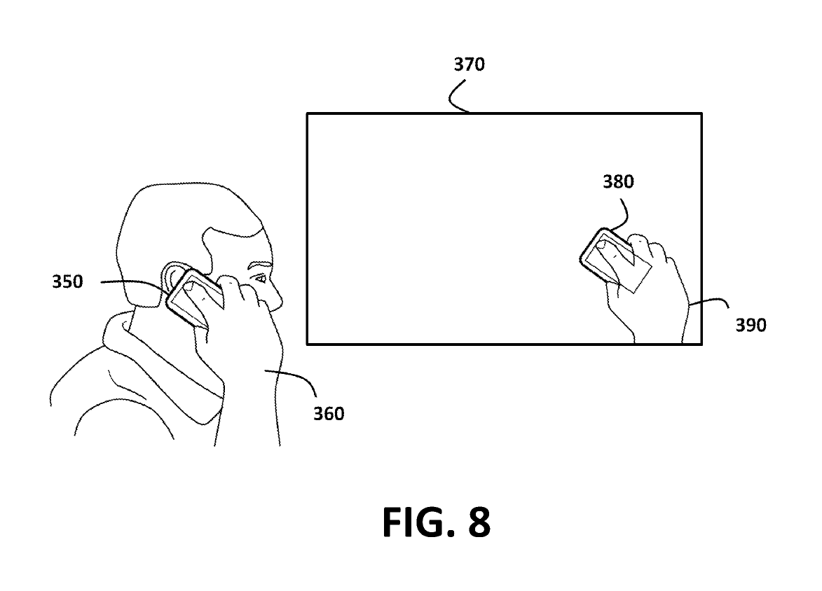

FIG. 8 illustrates a user of the present invention talking on a mobile phone 350 while holding this mobile phone with their hand 360. As shown in the figure, the user is watching a television 370 while the image of the mobile 380 phone being held by the user's hand 390 appears on the television screen. The image of the user's hand is transparent and overlays the image of the mobile phone. In this case, the digital data on the mobile phone screen can be presented on the image of the mobile phone on the television screen. With this easy interaction model in place, the user can easily interact with the application on their phone by moving their finger on the back side of the mobile phone. This allows the user to talk and interact with the mobile phone while simultaneously watching television:

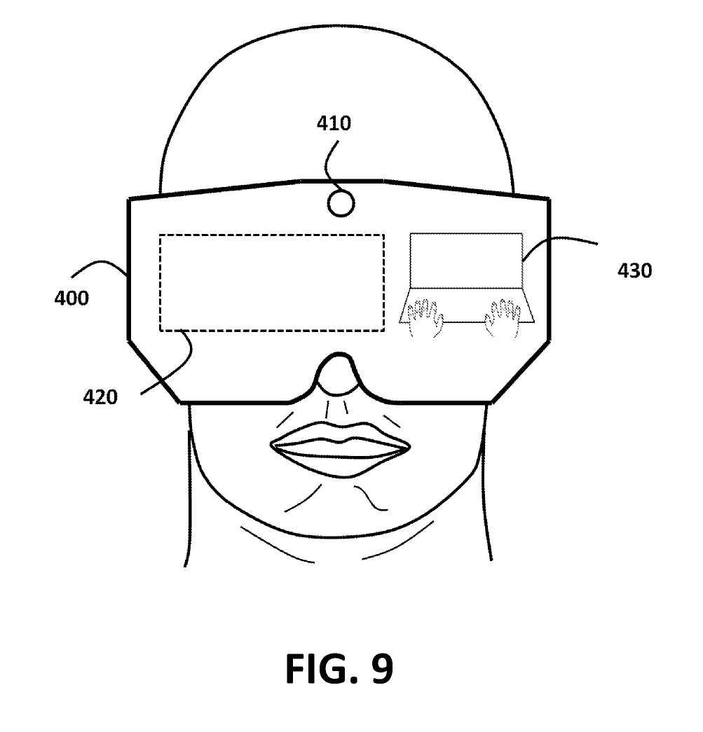

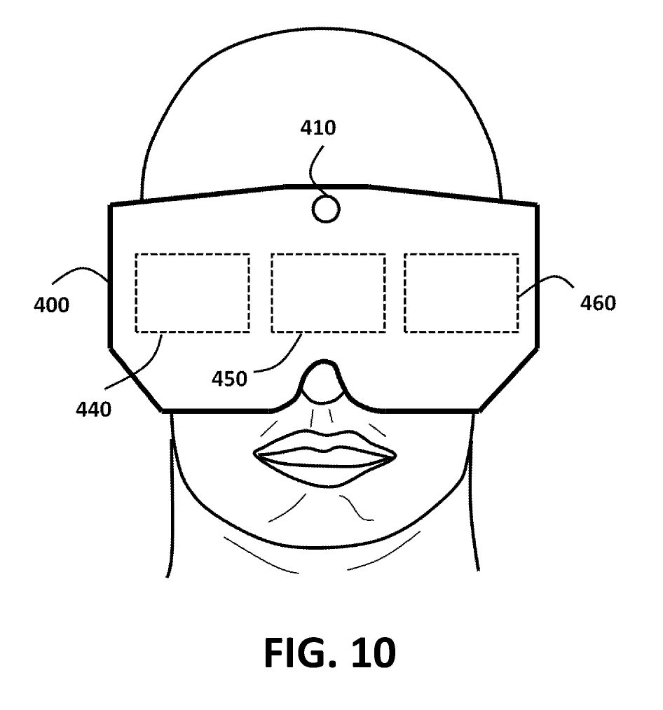

FIG. 9 illustrates a head mounted computer display 400 equipped with a digital camera 410. The head mounted computer display presents two images to the user's eyes, an image of a television screen 420 on the left, and an image of a laptop 430 on the right. The user can simultaneously watch the television and the laptop display and keyboard while using the laptop. The user can move or re-size any of the two images on the head mounted computer display to suit their preference. In FIG. 10, the head mounted display 400 presents three images 440-460. The three images can represent any three displays of a television, computer, tablet, mobile phone, or the like. Accordingly, the user can view multiple digital data presented on multiple electronic devices at the same time.

The same method can be utilized when using a mobile phone while wearing an optical head-mounted display (OHMD) in the form of eyeglasses such as GOOGLE GLASS. In this case too, the simulation of the user's hand and the picture of the mobile phone touchscreen are presented on the OHMD. Accordingly, the user does not need to stop or pause the phone call to use the mobile phone touchscreen when typing or generally interacting with a mobile phone application, browsing the Internet, or the like. Also, the present invention can be utilized by using a virtual retinal display (VRD), which is known as a retinal scan display or retinal projector, to draw a raster display directly onto the retina of the eye. In this case, the user sees what appears to be a conventional display floating in space in front of them.

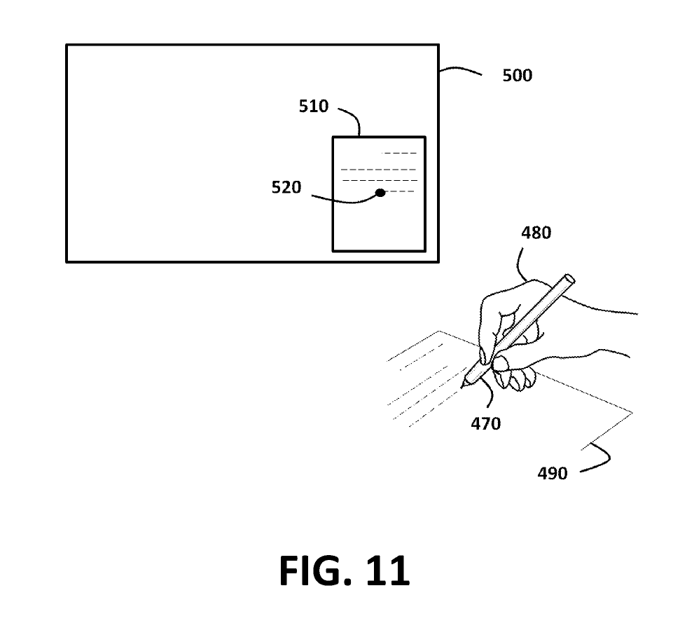

FIG. 11 illustrates a user holding a pencil 470 with their hand 480 to write on a piece of paper 490 while looking at a television screen 500. The image of the paper 510 and the position 520 of the pencil on the paper are presented on the television screen. In this case, the user of the present invention can write using a pencil and paper while keeping their eyes on the show or movie presented on the television screen, simultaneously seeing what they are writing. The pencil and paper can be replaced by a stylus and tablet that are used to write or draw on the tablet display. In this case, the user can watch television and simultaneously see the image of the tablet screen while writing or drawing on it.

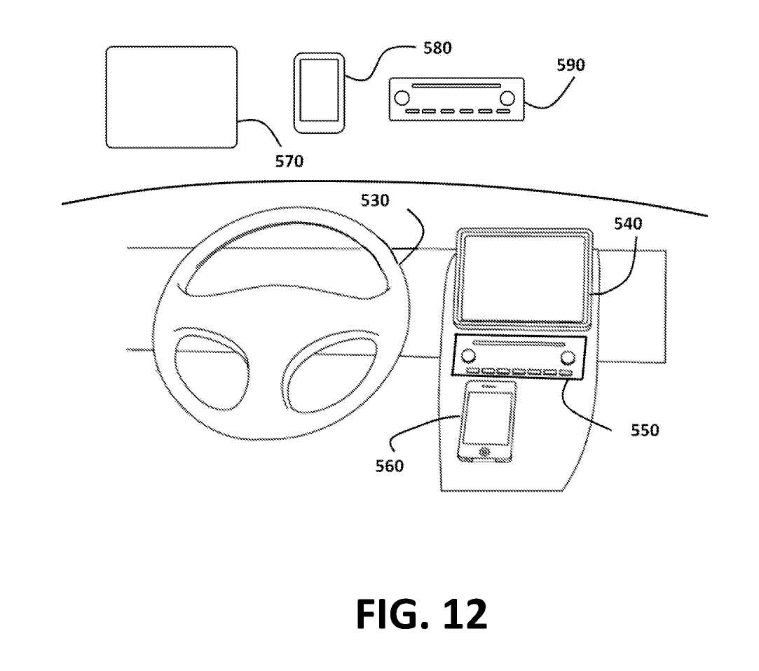

FIG. 12 illustrates a steering wheel 530 of a car where a GPS 540, car radio 550, and mobile phone 560 are positioned near the steering wheel to be accessible to the car driver. An image of the GPS 570, the car radio 580, and the mobile phone 590 appear on the front glass of the car in front of the car driver. Once the car driver touches the touchscreen of the GPS, car radio or mobile phone, the image of the driver's hands/digits is presented to overlay the image of the GPS, car radio or mobile phone. In this case, the images presented on the car glass are transparent, to allow the car driver to see the road in front of the car through these images. This way, the car driver can interact with various electronic devices of the car without the need to take their eyes away from the roads during driving. Accordingly, it becomes more saver and easier for the car driver to interact with various electronic devices without losing visual focus.

In summary, the present invention discloses a system that allows the user to use multiple electronic devices without gaze altering interruption occurring. This system increases the user's productivity by efficiently achieving multiple tasks at the same time. In one embodiment, the system is comprised of a first electronic device and a second electronic device. The first electronic device is comprised of a first display presenting a first digital data. The second electronic device is comprised of a second display and input device. The second display is presenting a second digital data simultaneously with the first digital data. An image of the second electronic device including the second display and the input device are presented on the first display, with an image of the user's hands/digits overlaying the image of the input device to indicate their relative location. The image of the user's hand/digits is transplant so that it is apparent to the user what parts of the input device their hands/digits are touching.

In one embodiment, as shown in FIGS. 1-6, the input device is a traditional keyboard of a laptop equipped with proximity sensors such as ultrasonic sensor that are configured to sense proximity and/or location of the user's hand relative to the keyboard. in some embodiments, the input device is equipped with a light sensor such as a camera to capture the image of the user's hand. The camera can also be a depth sensing camera that tracks the position or distance of the user's hand relative to the keyboard. In one embodiment, the data of the sensors or cameras are provided to the computer system of the laptop that sends this data, along with a screenshot of the laptop display, to the computer system of the television via wired or wireless communication channels (e.g., Bluetooth, infrared, radio frequencies, or the like).

In one embodiment, as shown in FIG. 7 the input device is a mobile phone keyboard that include a plurality of discrete input members. The discrete input members may take the form of an array of sensors (e.g., touch sensors, pressure sensors, force sensors, and so forth). The discrete input members may also take the form of switches, such as keys of a keyboard. Touching one or more of the switches provides the computer system with a data representing the position of the user's digits on the mobile phone keyboard.

In another embodiment, as shown in FIG. 8, the input device of the mobile phone is a touchscreen that utilizes capacitive or resistive touch sensing technology. The sides and back side of the mobile phone is equipped with touch sensors that detect the points of contact between the user's hand and mobile phone while holding the mobile phone, These points of contact allow the computer system of the mobile phone to simulate the shape of the user's hands/digits when holding the mobile phone during a phone call. This is achieved by utilizing a database that associates each unique points of contact with a simulation of the user's hand holding the mobile phone. Once the right simulation is identified in the database, it is presented on the television screen.

In one embodiment, as shown in FIGS. 9 and 10, the head mounted computer display is connected to the computer systems of the laptop and television. The sensors of the laptop provide the laptop computer system with immediate data representing the position of the user's hands relative to the laptop keyboard, then this data along with a screenshot of the laptop display are sent to the computer system of the head mounted computer display. In some embodiment, the television and laptop are connected to the head mounted computer display via wired or wireless communication channels (e.g., Bluetooth, infrared, radio frequencies, or the like).

In one embodiment, as shown in FIG. 11, the input device is in the form of a camera that captures the image of the paper and the position of the pencil on the paper. This camera can be located near the paper on a desk. The data of the camera is sent to the computer system of the television via wired or wireless communication channels (e.g., Bluetooth, infrared, radio frequencies, or the like). In another embodiment, as shown in FIG. 12, the touchscreens of the GPS, radio and mobile phone provide the computer systems of these devices with a data representing the points of contact with the user's hands/digits. This data is send to a computer system of a projector, along with screenshots of the GPS, radio and mobile phone, to be projected on the front glass of the car.

In some embodiments, the input device of the second electronic device is a blank surface that does not include keys, switches, labels or icons. This blank surface is equipped with sensors configured to sense the proximity and touch of the user hands/digits. When the image of this blank surface is presented on the display of the first electronic device, it includes a virtual keyboard, icons or menus, where the user can select of them to interact with the application presented on the display of the first input device.

The foregoing describes some example embodiments of systems and methods of the present invention. Although the foregoing discussion has presented specific embodiments, persons skilled in the art will recognize that changes may be made in form and detail without departing from the spirit and scope of the embodiments. Accordingly, the specific embodiments described herein should be understood as examples and not limiting the scope thereof.

1. A system of augment digital data of multiple electronic devices, where the system is comprised of;
a first electronic device comprised of a first computer system and a first display presenting a first digital data;
a second electronic device comprised of a second computer system, an input device, and a second display presenting a second digital data; and
sensors that sense the position of a user's hands relative to the input device and provide a data to the second computer system representing the position;
wherein the second computer system provides the first computer system with images representing the second digital data, the input device, and the position to be presented on the first display.

2. The system of claim 1 wherein the first display is a television screen and the second electronic device is a computer, tablet or mobile phone.

3. The system of claim 1 wherein the first display is a head mounted computer display and the second electronic device is a television, computer, tablet or mobile phone.

4. The system of claim 1 wherein the first electronic device is a projector and the first display is a surface that presents images projected from the projector on the surface.

5. The system of claim 1 wherein the sensors are proximity sensors that sense the position of a user's hand relative to the input device.

6. The system of claim 1 wherein the sensors are cameras that capture the picture of the user's hand relative to the input device.

7. The system of claim 1 wherein the sensors are depth sensing cameras that sense the distance between the user's hand and the input device.

8. The system of claim 1 wherein the first computer system and the second computer system are connected with each other via wired or wireless communication channels such as Bluetooth, infrared, or radio frequencies.

9. A system of augment digital data of multiple electronic devices, where the system is comprised of;
a first electronic device comprised of a first computer system and a first display presenting a first digital data; and
a second electronic device comprised of a second computer system, an input device, and a second display presenting a second digital data;
wherein the second computer system provides the first computer system with images representing the second digital data, the input device, and the points of contact between the input device and the user's hands.

10. The system of claim 9 wherein virtual spots appear on the image of the input device, on the first display, representing the points of contact.

11. The system of claim 9 further a database is utilized wherein the database associates each unique combination of points of contact with a shape of the user's hand to be presented on the first display.

12. The system of claim 9 wherein the first display is a television screen and the second electronic device is a computer, tablet or mobile phone.

13. The system of claim 9 wherein the first display is a head mounted computer display and the second electronic device is a television, computer, tablet or mobile phone.

14. The system of claim 9 wherein the first electronic device is a projector and the first display is a surface that presents images projected from the projector on the surface.

15. The system of claim 9 wherein the first computer system and the second computer system are connected to each other via wired or wireless communication channels such as Bluetooth, infrared, or radio frequencies.

16. A method of augmented digital data comprising;
capturing a first image representing a user's interaction with an electronic device;
capturing a second image representing the output of the display of the electronic device;
transmitting the first image and the second image to be presented on an additional display that simultaneously presents a digital data.

17. The method of claim 16 wherein the first image, the second image, and the digital data can be moved, re-sized, shown or hided on the additional display.

18. The method of claim 16 wherein the first image appears slanted on the additional display to suit the user's position or point of view

19. The method of claim 16 wherein the first image includes an image of the input device of the electronic device and an image of the user's hands position relative to the input device.

20. The method of claim 19 wherein the image of the user's hand is a transparent image that overlays the image of the input device.
